(19) United States
(12) Patent Application Publication
(10) Pub. No.: US 2009/0271117 A1
(43) Pub. Date: Oct. 29, 2009

(54) System and Method for Deep Formation Evaluation

(76) Inventors: Joseph A. Ayoub, Katy, TX (US); Cengiz Esmersoy, Sugar Land, TX (US); Tarek M. Habashy, Burlington, MA (US); Jacques R. Tabanou, Houston, TX (US)

Correspondence Address: SCHLUMBERGER IPC;ATTN: David Cate, 555 INDUSTRIAL BOULEVARD, MD-21, SUGAR LAND, TX, 77478, US

(21) Appl. No.: 12/427,818

(22) Filed: Apr. 22, 2009

Related U.S. Application Data
(60) Provisional application No. 61/047,159, filed on Apr. 23, 2008.

(51) Int. Cl. G01V 9/00

(52) U.S. Cl. 702/11; 901/1

(57) ABSTRACT

A technique facilitates formation evaluation by deploying tools in a subterranean environment. A logging tool is deployed in a wellbore to obtain formation related measurements. Additionally, one or more mobile robots also are positioned in the subterranean environment at unique positions that facilitate accumulation of data related to the formation. The data obtained from the logging tool and the one or more mobile robots is processed in a manner that enables deep formation evaluation.

### CROSS-REFERENCE TO RELATED APPLICATION

This application claims priority under 35 U.S.C. § 119(e) to U.S. Provisional Application Ser. No. 61/047,159, filed on Apr. 23, 2008, which is incorporated herein by reference.

### BACKGROUND

In oil and gas reservoir exploitations, formation evaluations are undertaken to gain a better understanding of the reservoir and to optimize production. Formation evaluation typically relies on interpretation of near wellbore measurements carried out with logging tools. The logging tools are designed to estimate formation properties, such as porosity, water saturation, rock mechanical properties, permeability, and other formation properties at sequential positions along the wellbore. The formation properties enable preparation of a reservoir model using cells to discretise the reservoir and to apply numerical methods for calculation of production performance.

However, the number of cells that can be used in a reservoir simulation is limited so as to maintain reasonable computation times. Consequently, upscaling of the formation parameters is employed to allow practical models with a manageable number of cells. Various methods can be used for upscaling data from several centimeters to several tens of meters scale and for inferring properties away from the wellbore. However, such approaches introduce additional uncertainties that limit the usefulness of the formation evaluation.

### SUMMARY

In general, the present invention provides a system and methodology that facilitate formation evaluation. A logging tool is deployed to obtain formation related measurements. One or more mobile robots also are positioned in the subterranean environment at unique positions that facilitate the accumulation of data related to the formation. The data obtained from the logging tool and the one or more mobile robots is processed in a manner that enables deep formation evaluation.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a formation evaluation system, according to an embodiment of the present invention;

FIG. 2 is a schematic illustration of another embodiment of the formation evaluation system in which mobile robots are deployed in cooperation with a logging system, according to an embodiment of the present invention;

FIG. 3 is a front view of one example of a mobile robot with sensors, according to an embodiment of the present invention;

FIG. 4 is a schematic view of a node based communication system utilizing mobile robots, according to an embodiment of the present invention;

FIG. 5 is a schematic illustration of a logging tool and mobile robots deployed in side holes extending from a wellbore, according to an embodiment of the present invention; and

FIG. 6 is schematic illustration of another arrangement of the logging tool deployed in a wellbore and mobile robots deployed in side holes extending from the wellbore, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention relates to a system and methodology to facilitate subterranean formation evaluation, and the technique is useful in performing deep formation evaluations. According to one embodiment, a logging tool is conveyed downhole along a wellbore to measure parameters. However, the information obtained by the logging tool is supplemented by deploying at least one mobile robot into deeper regions of the formation. For example, one or more mobile robots may be deployed into side holes extending from the wellbore, and those robots are operated to obtain deep formation measurements. The measurements taken by both the logging tool and the mobile robot or robots are processed to better evaluate a given subterranean formation.

The technique effectively provides a solution enabling a deep formation evaluation that includes the use of measurements reflecting the properties of a larger volume of rock away from the wellbore. The approach alleviates errors in upscaling and provides a more representative reservoir description. According to one embodiment, the technique utilizes deep measurements, constrained by the near-wellbore data, to build a reservoir model on a more desirable scale. The actual scale may be determined by the resolution of the deep measurements provided by the mobile robots. In performing this type of constrained inversion, the near-wellbore data is honored, and extra information is provided via the deep measurements on, for example, the inter-well space. The upscaling is performed based on physics and measurements rather than solely on statistical averaging and/or interpolation. In some applications, this approach can be used to provide a model that more accurately reflects the true reservoir conditions, thus enabling a simulation that provides a better predictive capability for use in oilfield management.

In one embodiment, semi-autonomous or autonomous robots are conveyed downhole into a wellbore while attached to a main logging tool. The robots are deployed away from the main logging tool either further away in the wellbore and/or in side holes extending into the formation from the main borehole. The robots can later be retrieved by reattaching them to the main logging tool. In an alternate embodiment, the robots are deployed permanently in side holes extending from the wellbore to enable permanent monitoring of the formation in a variety of applications, including production monitoring applications, water encroachment detection applications, steam assisted gravity drainage applications, and other applications.

The robots are designed to carry sensors and may utilize one or more types of sensors. For example, each robot may comprise a sensor module having, for example, temperature sensors, pressure probes/sensors, gravimeters, acoustics sensors, e.g. hydrophones and 3C geophones, electrical resistivity sensors, and other types of sensors. Additionally, the robots may comprise electromagnetic, acoustic or other types of transmitters and receivers, e.g. triaxial induction coils, for formation evaluation that may be conducted in cooperation with other robots and/or the logging tool. For acoustic and electromagnetic sensors, both directional and omni-directional sources can be employed over a wide frequency band or, alternatively, by performing a transient measurement.

The arrangement of logging tool and one or more mobile robots also facilitates performance of various measurements by triggering sources/transmitters (e.g. electromagnetic sources, acoustics sources, pressure sources, or other sources) on the logging tool and reading resulting signals with a receiver/sensor package carried by one or more of the mobile robots. Similarly, measurements may be obtained by triggering sources on one or more of the mobile robots and reading resulting signals with a receiver/sensor package carried by the logging tool.

A number of measurement configurations can be employed according to the environment, well configuration, and desired results. For example, one configuration utilizes long-offset, single-well logging by the robots that are deployed further away from a transmitter of the logging tool along the wellbore. In another configuration, logging measurements are performed as the mobile robot shuttles along a side hole to enable a plurality of directional transmitter-receiver spacings for imaging the formation away from the side holes. According to another configuration, “cross-hole” measurements are performed between robots in the side holes and the logging tool in the wellbore. Similarly, cross-hole measurements can be performed between mobile robots in two or more side holes. Various combinations of these configurations also can be used to further improve an understanding of the reservoir. In one embodiment, miniaturized robots are deployed in different locations and utilize a wireless sensor network technology to communicate.

In the past, traditional logging measurements have been carried out using predesigned transmitter-receiver arrays with fixed spacings that are assumed to apply to all formation scenarios. However, the use of sensors deployed on one or more mobile robots enables selective spacing of transmitters and receivers along the wellbore and in the formation. As a result, an operator can optimally place the transmitters and receivers to, for example, maximize the sensitivity of the measurements to facilitate evaluation of formation properties. The mobile robots can be designed to provide data in real time and thus enable a real-time survey.

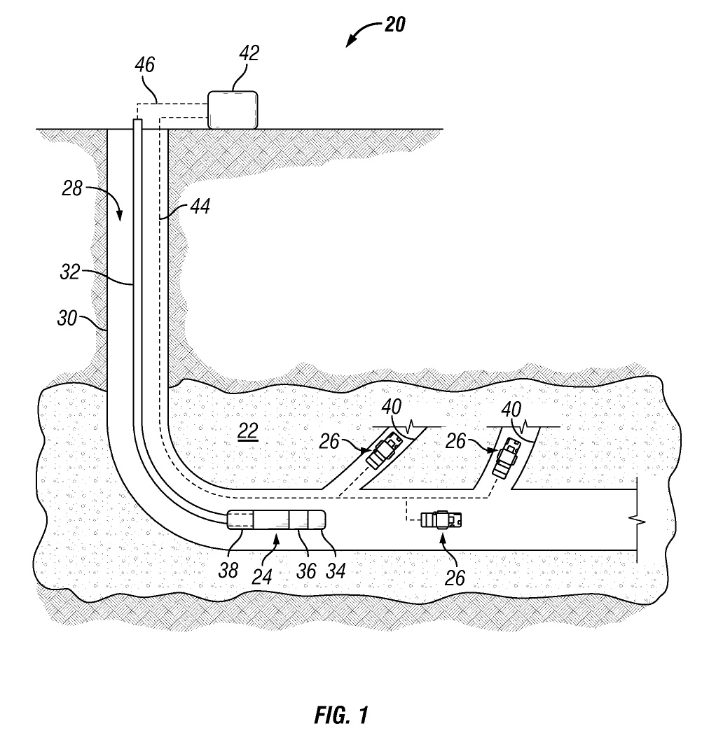

Referring generally to FIG. 1, one example of a system 20 for evaluating a subterranean formation is illustrated. In this example, system 20 is designed to enhance the evaluation of a subterranean formation 22 by employing a logging tool 24 and one or more mobile robots 26 to obtain various measurements related to subterranean formation parameters. The logging tool 24 is deployed downhole into a wellbore 28 drilled into formation 22. In this particular example, wellbore 28 comprises a deviated, e.g. horizontal, wellbore section 30, however system 20 can be utilized in generally vertical wellbores as described in greater detail below.

The logging tool 24 is conveyed downhole by a suitable conveyance 32, such as a wireline or coiled tubing. Depending on the specific application, the logging tool 24 may comprise a variety of components for measuring parameters along wellbore 28. For example, the logging tool 24 may comprise an electromagnetic transmitter 34 and an electromagnetic receiver 36 for performing surveys of the subterranean formation 22. The logging tool 24 also may comprise other types of sensors and components, including acoustic sensor systems, pressure sensor systems, and other systems and components. In some applications, logging tool 24 comprises a locomotion module 38, such as a tractor, to facilitate movement of the logging tool along sections of wellbore 28, such as deviated wellbore section 30.

As illustrated, one or more mobile robots 26 are deployed at a desired distance from logging tool 24 to enable an enhanced evaluation of formation 22. For example, one mobile robot 26 is illustrated as deployed in wellbore 28 at a desired distance from logging tool 24. Alternatively or in addition, mobile robots 26 can be deployed in side holes 40 that extend deeper into formation 22 from wellbore 28. The positioning of mobile robots 26, along with their sensor modules, is selected for a given environment and application so as to substantially improve the collection of data and, ultimately, the deep formation evaluation.

In some applications, a plurality of mobile robots 26 may be permanently deployed in the reservoir/formation 22 at an early stage of oilfield development. In this particular embodiment, the mobile robots may be used to assist in geo-steering subsequent wells by illuminating the reservoir with pulsed electromagnetic and/or acoustic energy. The pulsed electromagnetic and/or acoustic energy enables determination by triangulation of the location of the drill bit while a development well is drilled into the formation.

The mobile robots 26 may comprise a memory and be operated in a memory mode in which data collected by the robot sensors is stored. At the end of a logging operation, for example, the mobile robots 26 can be actuated and returned to the logging tool 24 for retrieval to the surface and evaluation of the stored data via a processing system 42. Alternatively, the one or more mobile robots 26 may be directly linked with processing system 42 via one or more communication lines 44, which may be hardwired communication lines or wireless communication lines. For example, data may be sent from each mobile robot 26 to processing system 42 via acoustic or electromagnetic wireless telemetry through formation 22. By directly linking the mobile robots 26 with processing system 42, data can be provided in real time to facilitate monitoring of formation parameters and control of both mobile robots 26 and logging tool 24.

Data, e.g. control signals, also may be communicated from processing system 42 to each of the mobile robots 26 to control the function of individual robots. For example, the movement of individual mobile robots 26 may be controlled to, for example, change the position of specific robots in wellbore 28 and/or side holes 40. The control signals may be sent from processing system 42 to mobile robots 26 via the same types of wired and/or wireless telemetry techniques used to relay data from the robots to processing system 42. Similarly, data may be communicated between logging tool 24 and processing system 42 via hardwired or wireless communication lines 46. Logging tool 24 also can serve as a hub for communicating with the mobile robots 26 via a wireless (or wired) communication protocol that enables relaying of data to or from the surface in real time. The mobile robots 26 also can be designed to self organize as a wireless network system and to utilize various communication technologies that assist in tracking mobile robot position and in managing data gathering and communication.

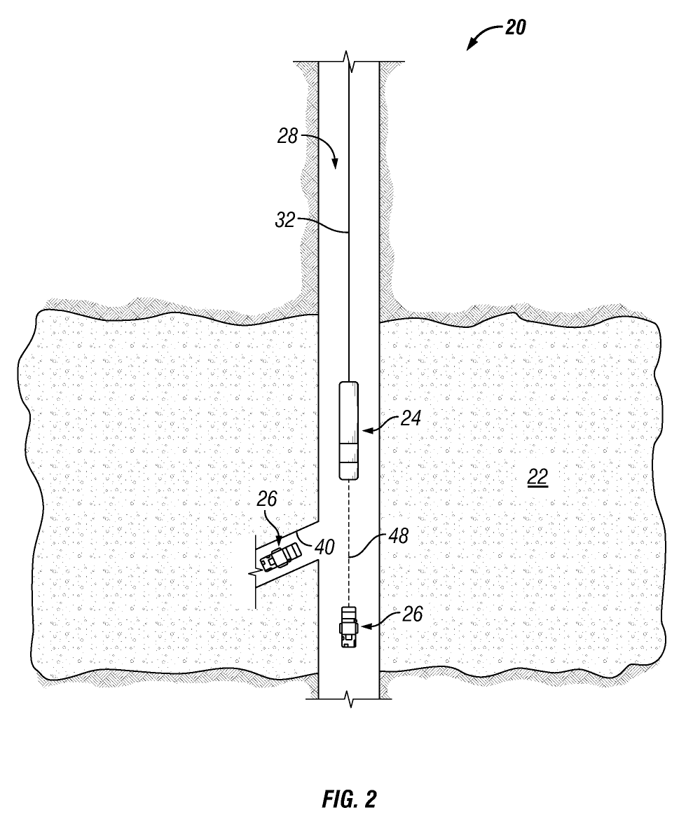

The present technique is useful in horizontal wells to provide deeper reservoir description using, for example, cross-hole measurements and/or sensors spaced further apart than in conventional logging. However, the present technique also is applicable in vertical wells, such as the substantially vertical well illustrated in the embodiment of FIG. 2. As with deviated wells, vertical well applications may utilize a variety of logging tools 24 and mobile robots 26. Additionally, the number and arrangement of mobile robots 26 can vary substantially depending on the environment, measured parameters, and goals of the logging operation.

In the example illustrated in FIG. 2, wellbore 28 extends down through formation 22. A plurality of mobile robots 26 is illustrated with one mobile robot 26 deployed in wellbore 28 below logging tools 24 and another mobile robot 26 illustrated in side hole 40 extending from the generally vertical wellbore 28. The mobile robot 26 deployed in wellbore 28 may be physically connected with logging tool 24 via a tether 48. In other embodiments, however, the mobile robots 26 may be unattached to logging tool 24 while deployed during a logging operation. The mobile robots 26 can be deployed by the logging tool 24 from the main wellbore 28 or by other devices. For example, the mobile robots 26 may be deployed by a drilling bottom hole assembly, by coiled tubing, or by other devices. Additionally, mobile robots 26 may be used as permanent sensors or to deliver permanent sensors able to facilitate logging in wellbore 28. In many applications, the mobile robots 26 are independently moved along wellbore 28 and/or side hole 40 in response to appropriate control signals provided by processing system 42.

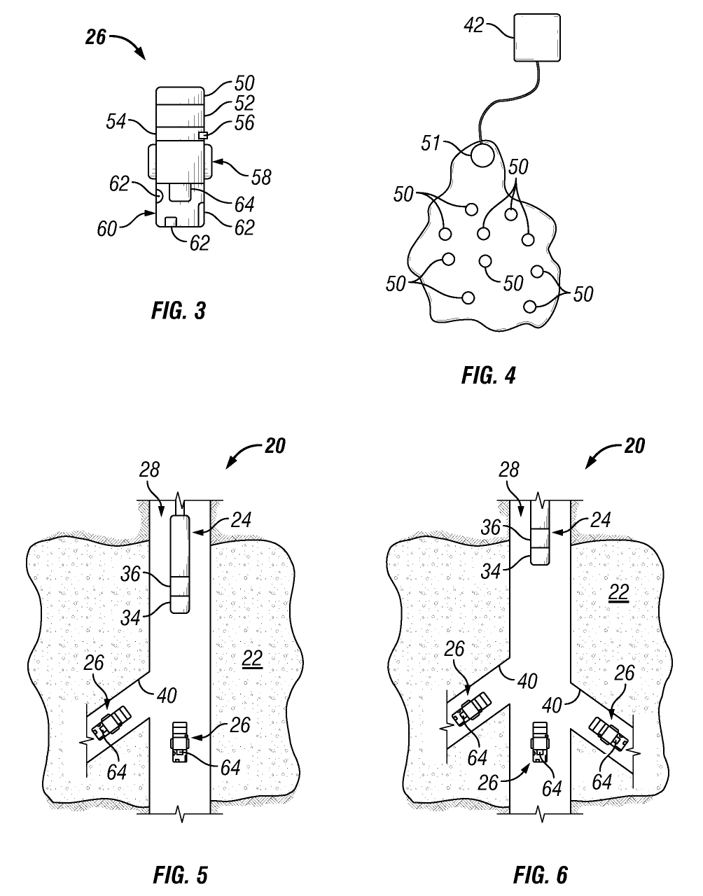

Each mobile robot 26 may be designed in a variety of configurations with many types of components used to assist navigation and measurements, depending on the environment, logging operation, parameters to be detected/monitored, and other desired goals of the system and methodology. Referring generally to FIG. 3, one embodiment of mobile robot 26 is illustrated. In this example, the mobile robot 26 comprises a communication module 50 designed to relay data to processing system 42 directly or via a main logging tool 24. Communication module 50 also may be used to receive instructions and other control signals from processing system 42 directly or via main logging tool 24 to control the movement and/or other actuations of mobile robot 26. In some applications, the communication module 50 also may comprise a memory for storing data that can later be downloaded to processing system 42.

Also, in other applications a plurality of mobile robots 26 is designed and deployed to utilize sensor network technology, such as a wireless sensor network technology, to assist in keeping track of mobile robot location and to relay measured data and control commands sent via processing system 42. As illustrated schematically in FIG. 4, the communication modules 50 can serve as nodes in a multi-hop wireless (or wired) sensor network. The data may be communicated to and from processing system 42 via a gateway node 51 located on, for example, the logging tool 24. The data may be relayed in real time.

Referring again to FIG. 3, mobile robot 26 may further comprise a power module 52, e.g. a battery, which can be used to provide power for sensors, for locomotion, and/or for other functions of the mobile robot. In some applications, robot 26 comprises a sample module 54 used to take physical samples of the surrounding formation. The sample module 54 may comprise a controllable mechanism 56, such as a telescopic mechanism, for retrieving samples of formation material. In some applications, the sample module 54 is used to obtain samples of the rock formation and the fluid impregnating the rock formation. The sample module may be designed to analyze the physical and petrophysical properties of the sample obtained and to transmit the results of such analysis to processing system 42 or to other equipment located at the surface or downhole. In this manner, for example, a well operator is able to detect the presence and amount of hydrocarbon in a sample and/or advancement of a waterfront in the vicinity of a mobile robot 26 positioned away from existing wells. The sample rock and/or fluid also can be stored and retrieved to the surface for analysis at a later date.

In a variety of applications, the mobile robot 26 is independently moved once separated from logging tool 24 via a locomotion module 58. The locomotion module 58 may comprise a tractor or other device operated in response to control signals sent from processing system 42. Power for locomotion module 58 may be provided by power module 52 to enable movement of robot 26 along wellbore 28 and/or side hole 40.

Each mobile robot also has a sensor module 60 that comprises a plurality of sensors 62 selected according to the well parameters that are to be detected and monitored for enhancing evaluation of the reservoir. Sensors 62 may comprise temperature sensors, pressure sensors, e.g. probes, gravimeters, acoustics sensors, e.g. hydrophones and 3C geophones, electrical resistivity sensors, and other types of sensors. In at least some applications, one or more of the mobile robots 26 also may comprise a device 64, such as a transmitter and/or receiver. By way of example, device 64 may comprise an electromagnetic transmitter and/or receiver, although the device 64 alternately may comprise acoustic, pressure, or other transmitters and/or receivers. In some applications, the electromagnetic device 64 may comprise triaxial induction coils designed to facilitate formation evaluation in cooperation with other robots and/or the logging tool 24.

Inclusion of electromagnetic, acoustic, pressure, or other devices 64 in one or more of the mobile robots 26 enables use of a wide variety of logging configurations with great flexibility and adjustability with respect to the distance between the transmitter and receiver. For example, one transmitter or receiver may be positioned on the logging tool 24 while the corresponding transmitter or receiver is positioned on one of the mobile robots 26. In the example illustrated in FIG. 5, the logging tool 24 comprises electromagnetic transmitter 34 and electromagnetic receiver 36, each of which may be used selectively in combination with a corresponding electromagnetic device 64 located on one or more mobile robots 26. However, transmitters 34, receivers 36, and devices 64 may comprise other types of logging related transmitters and receivers, including acoustic, pressure, and other types of transmitter/receivers.

In one example, logging tool electromagnetic transmitter 36 may be used in cooperation with a corresponding electromagnetic receiver 64 positioned on one of the mobile robots 26 or on a plurality of mobile robots 26. Similarly, the logging tool electromagnetic receiver 34 may be used in cooperation with a corresponding electromagnetic transmitter 64 positioned on one or more of the mobile robots 26 to optimize the data/information collected on formation 22. The information obtained is useful in constructing a reservoir model that more accurately reflects the true reservoir conditions and this enables a simulation with better predictive capability for use in oilfield management. In many applications, logging tool 24 is located in the wellbore during logging operations. However, one or more logging tools 24 also may be positioned at a surface location during a logging operation. If the logging tool or tools 24 are located at the surface and each tool comprises a transmitter/source, surface-to-wellbore measurements can be made while the mobile robot or robots 26 are moved along, for example, the side holes 40. Similarly, if the logging tool or tools 24 are located at the surface and each tool comprises a receiver, wellbore-to-surface measurements can be made while the mobile robots 26 are moved along the side holes 40 or along other subterranean features.

Another example of the flexibility afforded by a mobile robots 26 is illustrated in FIG. 6. In this embodiment, a plurality of mobile robots 26 comprises devices 64 that include either or both a transmitter and receiver, e.g. an electromagnetic transmitter and electromagnetic receiver. For example, an electromagnetic transmitter on one mobile robot 26 can be used in cooperation with a corresponding electromagnetic receiver on another mobile robot 26 to facilitate a logging operation and provide an improved understanding of the formation 22. As illustrated, mobile robots 26 can even be deployed in multiple side holes 40 to carry out logging measurements with corresponding transmitters and receivers. The flexible system 20 enables not only cross-hole measurements between the robots 26 in the side holes and the logging tool 24 but also cross-hole measurements between robots in two or more side holes 40. Many combinations of these configurations can be used to obtain additional logging measurements to expand the illumination and understanding of a given formation. Individual robots 26 also can be actuated via locomotion module 58 to shuttle along to different positions, thus enabling a plurality of transmitter-receiver spacings for imaging the formation 22.

The system 20 is useful in a variety of vertical and deviated wellbores and with many arrangements of side holes to provide an improved deep formation evaluation. The size and configuration of logging tool 24, as well as the components used to construct logging tool 24, can vary from one application to another according to factors, such as the environment and the parameters to be measured. With respect to the mobile robots 26, the number and arrangement of robots 26 may be adjusted as desired for a given logging operation. The robots may be deployed in the wellbore and/or in one or more side holes to obtain numerous measurements from a variety of configurations. Additionally, the size, structure, sensors, and other components in each mobile robot 26 may be selected according to the specific logging operation anticipated for a given formation. Deployment and retrieval of some or all of the mobile robots can be achieved independently or in combination with the logging tool.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method for evaluating a subterranean formation, comprising:
conveying a logging tool downhole along a wellbore;
deploying a mobile robot into a side hole extending from the wellbore;
measuring parameters along the wellbore with the logging tool;
obtaining deep formation measurements with the mobile robot; and
processing measurements taken with both the logging tool and the mobile robot to evaluate the formation.

2. The method as recited in claim 1, wherein deploying comprises deploying a plurality of mobile robots into a plurality of side holes.

3. The method as recited in claim 2, wherein obtaining comprises conducting long-offset, single-well logging with at least one mobile robot deployed a desired distance along the wellbore and away from a logging tool.

4. The method as recited in claim 1, wherein obtaining comprises conducting logging measurements with the mobile robot as the mobile robot is moved along the side hole to create several directional transmitter-receiver spacings for imaging the formation away from the side hole.

5. The method as recited in claim 2, wherein obtaining comprises conducting cross-hole measurements between mobile robots in the plurality of side holes and the logging tool in the wellbore.

6. The method as recited in claim 2, wherein obtaining comprises conducting cross-hole measurements between mobile robots deployed in at least two side holes of the plurality of side holes.

7. A method, comprising:
deploying a mobile robot downhole into a wellbore;
moving the mobile robot into a side hole extending from the wellbore; and
using the mobile robot to facilitate a logging operation.

8. The method as recited in claim 7, wherein deploying comprises deploying the mobile robot from a logging tool.

9. The method as recited in claim 7, wherein deploying comprises deploying the mobile robot from a bottom hole assembly.

10. The method as recited in claim 7, further comprising deploying a permanent sensor in the side hole.

11. A system, comprising:
a logging tool;
a mobile robot; and
a processing system, the processing system receiving data from the logging tool and the mobile robot while the logging tool is positioned in a wellbore and the mobile robot is positioned in a side hole extending from the wellbore.

12. The system as recited in claim 11, wherein the mobile robot comprises a plurality of mobile robots located in a plurality of side holes extending from the wellbore.

13. The system as recited in claim 11, wherein the mobile robot comprises a memory for storing data.

14. The system as recited in claim 12, wherein each mobile robot is remotely controlled from a surface location.

15. The system as recited in claim 11, wherein the logging tool and the mobile robot each comprises at least one of a transmitter and receiver such that the mobile robot is movable to adjust the distance between at least one transmitter and a corresponding receiver.

16. The system as recited in claim 11, wherein the mobile robot is able to take at least one physical sample from a surrounding formation.

17. The system as recited in claim 12, wherein the plurality of robots is miniaturized and deployed as a wireless sensor network able to utilize a wireless sensor network communication technology.

18. A method, comprising:
obtaining reservoir related measurements from a logging tool deployed in a wellbore;
obtaining deep measurements from a mobile robot positioned at a desired distance from the logging tool;
using a processing system to process the formation related measurements and the deep measurements; and
building a reservoir model on the processing system with the processed measurements.

19. The method as recited in claim 18, wherein obtaining deep measurements comprise obtaining temperature data and pressure data while the mobile robot is positioned in a side hole extending from the wellbore.

20. The method as recited in claim 19, wherein obtaining deep measurements comprises obtaining acoustic data and resistivity data while the mobile robot is positioned in a side hole extending from the wellbore.

21. The method as recited in claim 18, further comprising forming the logging tool with at least one of a transmitter and a receiver; and forming the mobile robot with at least one of a transmitter and a receiver.

22. A system for evaluating a subterranean formation, comprising:
a logging tool having at least one of a transmitter and a receiver; and
a mobile robot comprising the other of the at least one transmitter and the receiver, wherein the mobile robot is deployed in a subterranean environment, and the mobile robot may be moved to optimize the distance between the transmitter and the receiver for obtaining data on the subterranean environment during a logging operation.

23. The system as recited in claim 22, wherein the mobile robot comprises a plurality of mobile robots each having at least one transmitter or receiver to enable additional logging measurements.

24. The system as recited in claim 22, wherein the logging tool comprises at least one logging tool with each logging tool having a transmitter positioned at a surface location to conduct surface-to-wellbore measurements.

25. The system as recited in claim 22, wherein the logging tool comprises at least one logging tool with each logging tool comprising a receiver positioned at a surface location to conduct wellbore-to-surface measurements.
